(19) United States
(12) Patent Application Publication
(10) Pub. No.: US 2025/0136892 A1
(43) Pub. Date: May 1, 2025

(54) CHEMICAL PRETREATMENT PROCESS FOR WASTE FAT, OIL AND GREASE

(71) Applicant: FUZHOU UNIVERSITY, Fuzhou (CN)

(72) Inventors: Lilong JIANG, Fuzhou (CN); Kuan HUANG, Fuzhou (CN); Yanning CAO, Fuzhou (CN); Yongde MA, Fuzhou (CN); Zhenping CAI, Fuzhou (CN)

(73) Assignee: FUZHOU UNIVERSITY, Fuzhou (CN)

(21) Appl. No.: 18/789,043

(22) Filed: Jul. 30, 2024

(30) Foreign Application Priority Data
Oct. 31, 2023 (CN) 2023114322315

(51) Int. Cl. C11B 13/00; C11B 3/00; C11C 3/00

(52) U.S. Cl. CPC C11B 13/00; C11B 3/001; C11C 3/003

(57) ABSTRACT

A chemical pretreatment process for waste fat, oil and/or grease (FOG) includes three working sections: first, subjecting the waste FOG to esterification reaction to prepare a fatty acid methyl ester; second, subjecting a crude product obtained from the esterification reaction and a catalyst to liquid-liquid phase separation through a chromatograph device to obtain a crude product solution in a form of oil phase and a catalyst solution in a form of aqueous phase, respectively separating the aqueous phase and the oil phase through evaporation systems to obtain a crude product, catalyst and methanol and water, storing temporarily the crude product in a storage tank, and recycling the catalyst back to the reactor; and finally, refining the methanol aqueous solution through a distillation tower to obtain high-purity methanol, which is returned to the reactor for recycling, and introducing a resulting wastewater to a storage tank.

### TECHNICAL FIELD

The present disclosure relates to the technical field of renewable energy, and in particular to a chemical pretreatment process for waste fat, oil and/or grease (FOG).

### BACKGROUND

The vigorous development of biodiesel production projects not only meets the need to develop clean energy in China, but also fits the current national goal of “peak carbon dioxide emissions and carbon neutrality”. According to industry test data, every 1 ton of biodiesel used throughout the cycle can achieve 2.0 tons to 2.5 tons of carbon emission reductions. As certified by the Dutch Double Counting of the European Union that is the largest consumer of biomass energy in the world, compared with biodiesel produced from vegetable oils such as palm oil, soybean oil, and rapeseed oil as raw materials, biodiesel produced from waste FOG such as swill-cooked dirty oil, hogwash oil, and acidified oil as raw materials has higher carbon emission reduction properties and should be vigorously promoted and used. The waste FOG is a kind of by-product of the edible oil processing industry with wide and stable sources. Compared with animal fats and vegetable oils and microbial oils, the waste FOG is relatively cheap, and thus it has obvious cost advantages as raw materials for preparing second-generation biodiesel through hydrodeoxygenation.

However, the waste FOG has high fatty acid content and high acid value, and a hydrodeoxygenation reaction is carried out under high-temperature conditions and generates a large amount of water, which seriously affects the stability of the hydrogenation catalyst and causes the catalyst bed layer to be easily pulverized and deactivated. In addition, the waste FOG also contains a large number of impurities such as metals, phospholipids, and unsaponifiable substances. The deposition of such impurities on a surface of the hydrogenation catalyst also affects the stability of the hydrogenation catalyst. Therefore, when the waste FOG is used as raw materials to prepare second-generation biodiesel, the device needs to be frequently shut down to replace the catalyst, thus preventing stable run for a long period and resulting in high operating cost. In the existing technology for preparing the second-generation biodiesel by using the hydrodeoxygenation method, the waste FOG is generally pretreated by using conventional physical methods such as water method, acid washing, alkali washing, and adsorption, which can remove some impurities, but has a relatively low overall efficiency, and the conventional physical pretreatment methods cannot fundamentally address the problem of high acid value of the waste FOG.

### SUMMARY

In view of the deficiencies of the prior art, the present disclosure provides a chemical pretreatment process for waste FOG, which makes it possible to greatly reduce an acid value of the waste FOG, transform the waste FOG into a liquid with good fluidity, and significantly remove impurities such as metals, phospholipids, and unsaponifiable substances in the waste FOG. The waste FOG subjected to the chemical pretreatment process has a low loss rate (the yield is 98% or more). When such waste FOG is applied into a hydrodeoxygenation reaction section, it can greatly prolong the service life of the subsequent hydrogenation catalyst, significantly extend the operating time of the hydrodeoxygenation reaction section, immensely reduce catalyst consumption and operating costs, and improve device operation efficiency and production efficiency.

The present disclosure provides the following technical solutions.

The chemical pretreatment process for waste FOG includes three working sections: first, subjecting the waste FOG to esterification reaction to prepare a fatty acid methyl ester; second, subjecting a crude product obtained from the esterification reaction and a catalyst to liquid-liquid phase separation through a chromatograph device to obtain a crude product solution in a form of oil phase and a catalyst solution in a form of aqueous phase, respectively separating the aqueous phase and the oil phase through evaporation systems to obtain a crude product, catalyst and methanol and water, storing temporarily the crude product in a storage tank, and recycling the catalyst back to the reactor; and finally, refining the methanol aqueous solution through a distillation tower to obtain high-purity methanol, which is returned to the reactor for recycling, and introducing a resulting wastewater to a storage tank. Specifically, the chemical pretreatment process for waste FOG includes steps of:
S1, mixing a fresh methanol from a main pipeline from a boundary and a recycled ionic liquid from a catalyst recovery evaporation system to obtain a mixture, and then introducing the mixture into a catalyst preparation tank V101; adding a fresh ionic liquid catalyst to the catalyst preparation tank V101 and then stirring and dissolving to obtain a catalyst solution, and feeding out the catalyst solution through a catalyst conveying pump P101A/B; mixing a recycled methanol from a methanol recovery tower T101 with the waste FOG from the main pipeline from the boundary, followed by mixing with the catalyst solution, and then conveying to a static mixer X101 through a pipeline and conducting mixing fully to obtain a mixed system; introducing the mixed system into a 1# esterification reactor R101 and subjecting methanol and the waste FOG to esterification reaction under action of an ionic liquid catalyst at a preset reaction temperature and pressure to generate a fatty acid methyl ester and water; and introducing unreacted methanol, unreacted waste FOG and a crude product generated in the 1# esterification reactor R101 into a 2# esterification reactor R102 and continuing the esterification reaction to further generate the fatty acid methyl ester and water;
S2, introducing a crude product obtained after the esterification reaction in the 2# esterification reactor R102 to a filter F101A/B through a 2# external circulation pump P103A/B; removing a solid impurity precipitated in the filter F101A/B, and collecting the solid impurity into a solid-waste treatment and storage tank; introducing a filtered crude product into a chromatograph device V102 and conducting oil-water two-phase separation to obtain an oil phase and aqueous phase, where the oil phase mainly includes a fatty acid methyl ester, methanol, water, and some unreacted waste FOG, and the aqueous phase mainly includes methanol, an ionic liquid, and water generated by reactions;
S3, introducing the oil phase product obtained by the oil-water separation in the chromatograph device V102 into a crude product separation and evaporation system, and conducting flash evaporation to separate out methanol and a crude product by boiling point differences among water, methanol, and the fatty acid methyl ester; introducing a gas phase product obtained by the crude product separation and evaporation system, i.e., methanol and water into a subsequent methanol recovery system, and introducing the crude product containing the fatty acid methyl ester and partially unreacted waste FOG into a product storage tank through a crude product conveying pump P104A/B;
S4, introducing a product of the aqueous phase obtained by the oil-water separation in the chromatograph device V102 into the catalyst recovery evaporation system, and conducting flash evaporation to separate out the ionic liquid, methanol, and water by boiling point differences among the ionic liquid, methanol, and water; introducing a gas phase product obtained by the catalyst recovery evaporation system, i.e., methanol and water into the subsequent methanol recovery system, returning most of the recovered ionic liquid catalyst to the catalyst preparation tank V101, and introducing a deactivated ionic liquid into a waste catalyst recovery storage tank; and
S5, cooling the methanol and water from the crude product separation and evaporation system and the catalyst recovery evaporation system into a liquid through a methanol condenser E105, and introducing the liquid into a methanol storage tank V105; pressurizing the liquid by a methanol feed pump P105A/B, and then introducing the liquid into the methanol recovery tower T101 and conducting distillation separation to obtain high-purity gas phase methanol at a tower top and wastewater at a tower bottom; cooling the high-purity gas phase methanol by a tower top cooler E107 to obtain a methanol product, refluxing a part of the methanol product, and conveying back a part of the methanol product to the 1# reactor R101 by a reflux pump P107A/B; and conveying the wastewater obtained at the tower bottom to a waste liquid recovery storage tank through a waste liquid discharge pump P106A/B.

In some embodiments, the crude product separation and evaporation system in step S3 includes a 1# evaporator E103 and a 1# gas-liquid separator V103 disposed in series; and
the catalyst recovery evaporation system in step S4 includes a 2# evaporator E104 and a 2# gas-liquid separator V104 disposed in series.

In some embodiments, the ionic liquid catalyst in step S1 is a Bronsted acid protic ionic liquid prepared from a linear or heterocyclic tertiary amine compound and sulfuric acid, benzenesulfonic acid, or p-toluenesulfonic acid by one-step neutralization reaction between.

In some embodiments, in step S1, a mass ratio of reaction raw materials to the catalyst is in a range of waste FOG:methanol:catalyst of 1:(0.4 to 1.6):(0.05 to 0.50), the 1# esterification reactor R101 and the 2# esterification reactor R102 have an operating temperature of 60° C. to 90° C., a reaction pressure of 0.1 MPa to 0.5 MPa, and a material residence time in both esterification reactors of 3 h to 5 h.

In some embodiments, the chromatograph device V102 in step S2 has an operating temperature of 40° C. to 80° C., and an operating pressure of 0.1 MPa to 0.5 MPa.

In some embodiments, in step S3, the crude product separation and evaporation system has an operating temperature of 105° C. to 165° C., an operating pressure of 0.1 MPa to 0.5 Mpa; a low-pressure steam of a heating medium in the 1# evaporator E103 has a temperature of 140° C. to 180° C., and a pressure of 0.3 MPa to 0.8 Mpa; and a heated steam condensate is supplied to a previous esterification reaction section for providing heat; and
in step S4, the catalyst recovery evaporation system has an operating temperature of 100° C. to 160° C., and an operating pressure of 0.1 MPa to 0.5 Mpa; a low-pressure steam of a heating medium in the 2# evaporator E104 has a temperature of 140° C. to 180° C., and a pressure of 0.3 MPa to 0.8 MPa; and a heated steam condensate is supplied to the previous esterification reaction section for providing heat.

In some embodiments, in step S5, the methanol recovery tower T101 has an operating pressure of 0.1 MPa to 0.5 MPa, an operating temperature at the tower top of 40° C. to 80° C., an operating temperature at the tower bottom of 80° C. to 120° C., and an operating reflux ratio of 1.0 to 5.0; a low-pressure steam of a heating medium at the tower bottom has a temperature of 100° C. to 140° C., and a pressure of is 0.1 MPa to 0.3 MPa; and a heated steam condensate is supplied to the previous esterification reaction section for providing heat.

In some embodiments, the both esterification reactors in step S1 are stirred tank reactors internally provided with an inner coil heater and an external circulation heat exchanger E101/E102 for heating, and a heating medium is a steam condensate from a subsequent working section. When the reaction is out of control and overtemperature occurs, recycled water is added to reduce a temperature of the reaction through the external circulation heat exchanger E101/E102, and a reaction pressure is controlled by supplementing a low-pressure nitrogen.

In some embodiments, in order to prevent clogging from affecting normal operation, the filter connecting with the chromatograph device V102 in step S2 is provided with two filter devices disposed in parallel, namely a first filter F101A and a second filter F101B, one is put into normal use and the other is regularly back-flushed.

Some embodiments of the present disclosure have the following advantages.

The chemical pretreatment process according to the present disclosure makes it possible to greatly reduce the acid value of the waste FOG, transform the waste FOG into a liquid with good fluidity, and significantly remove impurities such as metals, phospholipids, and unsaponifiable substances in the waste FOG, thereby providing high-quality raw oil for producing second-generation biodiesel through a hydrodeoxygenation method. Specifically, by the chemical pretreatment process according to the present disclosure, the acid value of the waste FOG can be reduced to 10 mg KOH/g to 30 mg KOH/g, and removal rates of Fe, Ca, Na, P, and unsaponifiable substances reach 99% or more, 99% or more, 80% or more, 60% or more, and 50% or more, respectively, indicating that the impurity removal effect is very remarkable.

### BRIEF DESCRIPTION OF THE DRAWINGS

In order to illustrate the specific embodiments of the present disclosure more clearly, the drawings needed to be used in the specific embodiments will be briefly introduced below. Obviously, the drawings in the following description are some embodiments of the present disclosure. Other drawings can be obtained by those skilled in the art based on these drawings without creative effort.

FIG. 1 is a schematic diagram showing a process flow of a pretreatment reaction section according to one embodiment of the present disclosure; and

FIG. 2 is a schematic diagram showing a process flow of a catalyst recovery section according to one embodiment of the present disclosure.

### DETAILED DESCRIPTION OF THE EMBODIMENTS

The technical solution of the present disclosure will be clearly and completely described below in conjunction with the drawings. Obviously, the described embodiments are some, not all, of the embodiments of the present disclosure. Based on the embodiments of the present disclosure, all other embodiments obtained by those skilled in the art without creative effort fall within the scope of the present disclosure.

### Example 1

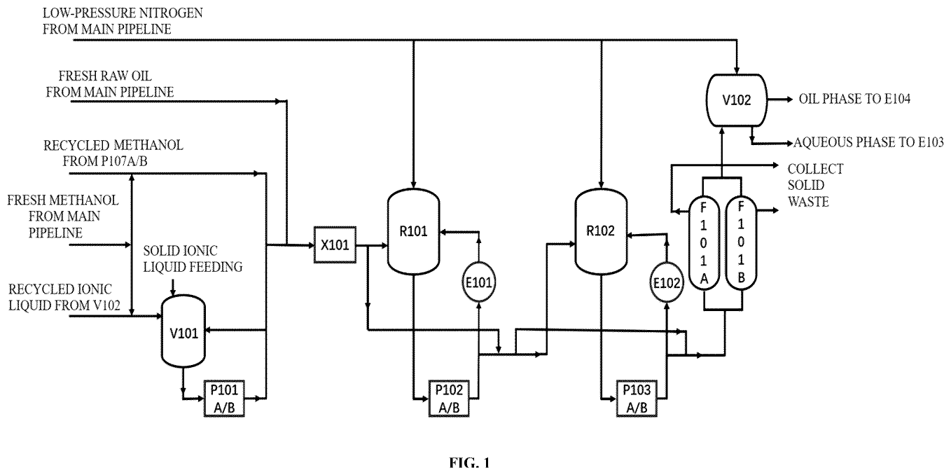

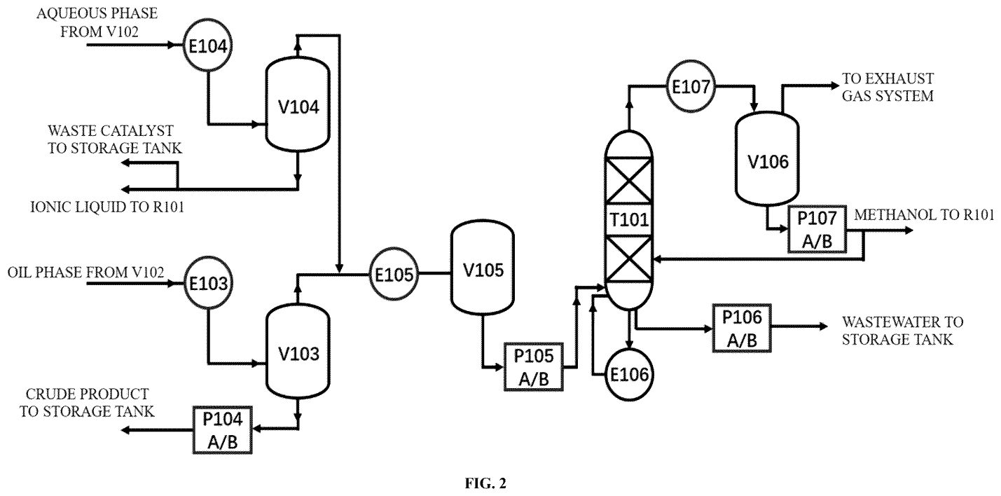

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution, such that a mass ratio of the waste FOG to methanol to the catalyst was waste FOG:methanol:catalyst=1:1.25:0.1 to obtain a mixed system. The mixed system was conveyed to a static mixer X101 through a pipeline and mixed fully therein and then introduced into a 1# esterification reactor R101, where a temperature of an inner coil heating fluid in the reactor was set to 80° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 80° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 60° C. The separated oil phase mainly included fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 140° C., and a low-pressure steam of 0.3 Mpa was used for heating), and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 150° C., and a low-pressure steam of 0.7 MPa was used for heating) and subjected to flash evaporation to separate out an ionic liquid, methanol, and water by boiling point differences among the ionic liquid, methanol, and water. The gas phase product obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 55° C., a temperature of a tower bottom was 105° C., and a reflux ratio was 2.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

In order to clearly illustrate the actual effect of the present disclosure, the acid value and impurity content of raw oil, that is, the waste FOG before and after the chemical pretreatment were measured. The results are shown in the following table.

TABLE 1
Impurity content of waste FOG before and after chemical pretreatment

| | | Acid value | Fe | Ca | Na | P | Unsaponifiable |
|---|---|---|---|---|---|---|---|
| Sample | Appearance | (mg/g) | (ppm) | (ppm) | (ppm) | (ppm) | substance (%) |
| Before | Yellow | 145.55 | 259.92 | 74.70 | 10.44 | 22.07 | 2.98 |
| chemical | solid | | | | | | |
| pretreatment | | | | | | | |
| After | Brown | 12.20 | 1.12 | 0.22 | 0.95 | 5.32 | 0.86 |
| chemical | liquid | | | | | | |
| pretreatment | | | | | | | |

As seen from the above table, the chemical pretreatment process according to the present disclosure makes it possible to greatly reduce the acid value of the waste FOG, transform the waste FOG into a liquid with good fluidity, and significantly remove impurities such as metals, phospholipids, and unsaponifiable substances in the waste FOG, thereby providing high-quality raw oil for producing second-generation biodiesel through a hydrodeoxygenation method.

### Example 2

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed and then mixed with the catalyst solution, such that a mass ratio of the waste FOG to methanol to the catalyst was waste FOG:methanol:catalyst=1:1.25:0.1 to obtain a mixed system. The mixed system was conveyed to a static mixer X101 through a pipeline and mixed fully therein and then introduced into a 1# esterification reactor R101, where a temperature of an inner coil heating fluid in the reactor was set to 60° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 80° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 60° C. The separated oil phase mainly included a fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 140° C., and a low-pressure steam of 0.6 Mpa was used for heating), and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing the fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 150° C., and a low-pressure steam of 0.3 MPa was used for heating) and subjected to flash evaporation to separate out an ionic liquid, methanol, and water by boiling point differences among the ionic liquid, methanol, and water. The gas phase product obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B, and introduced into the methanol recovery tower T101, and then subjected to distillation separation, where a temperature of a tower top was 75° C., a temperature of a tower bottom was 115° C., and a reflux ratio was 3.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

### Example 3

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution such that a mass ratio of the waste FOG to methanol to the catalyst was waste FOG:methanol:catalyst=1:0.75:0.3 to obtain a mixed system. The mixed system was conveyed to a static mixer X101 through a pipeline and mixed fully therein and then introduced into a 1# esterification reactor R101, where a temperature of an inner coil heating fluid in the reactor was set to 80° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 80° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 70° C. The separated oil phase mainly included a fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 180° C., and a low-pressure steam of 0.3 Mpa was used for heating), and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing a fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 140° C., and a low-pressure steam of 0.8 MPa was used for heating) and subjected to flash evaporation to separate out an ionic liquid, methanol, and water by boiling point differences among the ionic liquid, methanol, and water. The gas phase product obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 80° C., a temperature of a tower bottom was 120° C., and a reflux ratio was 4.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

### Example 4

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution such that a mass ratio of the waste FOG to methanol to the catalyst was waste FOG:methanol:catalyst=1:1.6:0.05 to obtain a mixed system. The mixed system was conveyed to a static mixer X101 through a pipeline and mixed fully therein and then introduced into a 1# esterification reactor R101, where a temperature of an inner coil heating fluid in the reactor was set to 70° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 90° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 80° C. The separated oil phase mainly included a fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 160° C., and a low-pressure steam of 0.6 Mpa was used for heating) and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing the fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 180° C., and a low-pressure steam of 0.3 MPa was used for heating) and subjected to flash evaporation to separate out an ionic liquid, methanol, and water by boiling point differences among the ionic liquid, methanol, and water. The gas phase product obtained by the catalyst recovery evaporation system, i.e., methanol and water introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 55° C., a temperature of a tower bottom was 105° C., and a reflux ratio was 5.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

### Example 5

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution such that a mass ratio of the waste FOG to methanol to the catalyst was waste FOG:methanol:catalyst=1:0.4:0.5 to obtain a mixed system. The mixed system was conveyed to a static mixer X101 through a pipeline and mixed fully therein and then introduced into a 1# esterification reactor R101, where a temperature of an inner coil heating fluid in the reactor was set to 60° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 90° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 50° C. The separated oil phase mainly included the fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 140° C., and a low-pressure steam of 0.8 Mpa was used for heating), and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing the fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 150° C., and a low-pressure steam of 0.5 MPa was used for heating) and subjected to flash evaporation to separate out an ionic liquid, methanol, and water by boiling point differences among the ionic liquid, methanol, and water. The gas phase product obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 60° C., a temperature of a tower bottom was 120° C., and a reflux ratio was 1.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

### Example 6

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution, such that a mass ratio of the waste FOG to methanol to the catalyst was waste FOG:methanol:catalyst=1:0.8:0.05 to obtain a mixed system. The mixed system was conveyed to a static mixer X101 through a pipeline and mixed fully therein and then introduced into a 1# esterification reactor R101, where a temperature of an inner coil heating fluid in the reactor was set to 90° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 80° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 40° C. The separated oil phase mainly included the fatty acid methyl ester, methanol, water, and some unreacted waste FOG, and the separated aqueous phase mainly included methanol, an ionic liquid, and water generated by the reaction.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 180° C., and a low-pressure steam of 0.3 Mpa was used for heating), and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing a fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 140° C., and a low-pressure steam of 0.8 MPa was used for heating) and subjected to flash evaporation to separate out an ionic liquid, methanol, and water by boiling point differences among the ionic liquid, methanol, and water. The gas phase products obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 80° C., a temperature of a tower bottom was 80° C., and a reflux ratio was 2.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

### Example 7

As shown in FIG. 1 and FIG. 2, a chemical pretreatment process for waste FOG according to the present disclosure was conducted as follows.
S1. Fresh methanol from a main pipeline from a boundary and a recycled ionic liquid from a catalyst recovery evaporation system (including a 2# evaporator E104 and a 2# gas-liquid separator V104 disposed in series) were mixed and then introduced into a catalyst preparation tank V101. A fresh ionic liquid catalyst was also added to the catalyst preparation tank V101, and then stirred and dissolved to obtain a catalyst solution. The catalyst solution was fed out through a catalyst conveying pump P101A/B. A recycled methanol from a methanol recovery tower T101 and waste FOG from the main pipeline from the boundary were mixed, and then mixed with the catalyst solution, such that a mass ratio of the waste FOG to methanol to the catalyst was waste FOG:methanol:catalyst=1:1.25:0.1 to obtain a mixed system. The mixed system was conveyed to a static mixer X101 through a pipeline and mixed fully therein and then introduced into a 1# esterification reactor R101, where a temperature of an inner coil heating fluid in the reactor was set to 70° C., and methanol and the waste FOG in the reactor was subjected to an esterification reaction under the action of the ionic liquid catalyst to generate a fatty acid methyl ester and water. Unreacted methanol, unreacted waste FOG, and a crude product generated in the 1# esterification reactor R101 were then introduced into a 2# esterification reactor R102 and continued to subject to esterification reaction to further generate the fatty acid methyl ester and water, where a temperature of an inner coil heating fluid in the 2# esterification reactor R102 was set to 90° C.
S2. The crude product obtained by the reaction in the 2# esterification reactor R102 was conveyed to a filter F101A/B through 2# external circulation pump P103A/B. Solid impurities precipitated in the filter F101A/B were removed and collected into a solid-waste treatment and storage tank, and the filtered crude product was introduced into a chromatograph device V102 and subjected to oil-water two-phase separation to obtain an oil phase and an aqueous phase. In order to improve the oil-water phase separation efficiency, an operating temperature of the chromatograph device V102 remained at 60° C. The separated oil phase mainly included the fatty acid methyl ester, methanol, water, and some unreacted waste FOG, and the separated aqueous phase mainly included methanol, an ionic liquid, and water generated by reactions.
S3. The oil phase product obtained by the oil-water separation in the chromatograph device V102 was introduced into a crude product separation and evaporation system (including a 1# evaporator E103 and a 1# gas-liquid separator V103 disposed in series, in which a temperature of the 1# evaporator E103 was 150° C., and a low-pressure steam of 0.7 Mpa was used for heating) and subjected to flash evaporation to separate out methanol and a crude product by boiling point differences among water, methanol, and the fatty acid methyl ester. The gas phase products obtained by the crude product separation and evaporation system, i.e., methanol and water were introduced into a subsequent methanol recovery system, and the crude product containing the fatty acid methyl ester and partially unreacted waste FOG was introduced into a product storage tank through a crude product conveying pump P104A/B.
S4. The aqueous phase product obtained by the oil-water separation in the chromatograph device V102 was introduced into the catalyst recovery evaporation system (including a 2# evaporator E104 and a 2# gas-liquid separator V104 disposed in series, in which a temperature of the 2# evaporator E104 was 180° C., and a low-pressure steam of 0.8 MPa was used for heating) and subjected to flash evaporation to separate out an ionic liquid, methanol, and water by boiling point differences among the ionic liquid, methanol, and water. The gas phase products obtained by the catalyst recovery evaporation system, i.e., methanol and water were introduced into the subsequent methanol recovery system, most of the recovered ionic liquid catalyst returned to the catalyst preparation tank V101, and a deactivated ionic liquid was introduced into a waste catalyst recovery storage tank.
S5. The methanol and water from the 1# gas-liquid separator V103 and the 2# gas-liquid separator V104 were cooled into a liquid through a methanol condenser E105, then introduced into a methanol storage tank V105, pressurized by a methanol feed pump P105A/B and introduced into the methanol recovery tower T101, and then subjected to distillation separation, where a temperature of a tower top was 40° C., a temperature of a tower bottom was 120° C., and a reflux ratio was 1.0. High-purity gas phase methanol obtained at the tower top was cooled by a tower top cooler E107, a part of a resulting product was refluxed, and a part of the resulting product was conveyed back to the 1# reactor R101 by a reflux pump P107A/B. Wastewater obtained at the tower bottom was conveyed to a waste liquid recovery storage tank through a waste liquid discharge pump P106A/B.

Obviously, the above-described embodiments are only examples for clear illustration and are not intended to limit the implementation. For those skilled in the art, other different forms of changes or modifications can be made based on the above description. An exhaustive list of all embodiments is neither necessary nor possible. The obvious changes or modifications derived therefrom are still within the scope of the present disclosure.

1.-9. (canceled)

10. A chemical pretreatment process for waste fat, oil and/or grease (FOG) comprising:
S1, mixing a fresh methanol from a main pipeline from a boundary and a recycled ionic liquid from a catalyst recovery evaporation system to obtain a mixture, and then introducing the mixture into a catalyst preparation tank (V101); adding a fresh ionic liquid catalyst to the catalyst preparation tank (V101) and then stirring and dissolving to obtain a catalyst solution, and feeding out the catalyst solution through a catalyst conveying pump (P101A/B); mixing a recycled methanol from a methanol recovery tower (T101) with the waste FOG from the main pipeline from the boundary, followed by mixing with the catalyst solution, and then conveying to a static mixer (X101) through a pipeline and conducting mixing fully to obtain a mixed system; introducing the mixed system into a 1# esterification reactor (R101) and subjecting methanol and the waste FOG to esterification reaction under action of an ionic liquid catalyst at a preset reaction temperature and pressure to generate a fatty acid methyl ester and water; and introducing unreacted methanol, unreacted waste FOG and a crude product generated in the 1# esterification reactor (R101) into a 2# esterification reactor (R102) and continuing the esterification reaction to further generate the fatty acid methyl ester and water;
S2, introducing a crude product obtained after the esterification reaction in the 2# esterification reactor (R102) to a filter (F101A/B) through a 2# external circulation pump (P103A/B); removing a solid impurity precipitated in the filter (F101A/B), and collecting the solid impurity into a solid-waste treatment and storage tank; introducing a filtered crude product into a chromatograph device (V102) and conducting oil-water two-phase separation to obtain an oil phase and an aqueous phase, wherein the oil phase mainly comprises a fatty acid methyl ester, methanol, water, and some unreacted waste FOG, and the aqueous phase mainly comprises methanol, an ionic liquid, and water generated by reactions;
S3, introducing the oil phase product obtained by the oil-water separation in the chromatograph device (V102) into a crude product separation and evaporation system, and conducting flash evaporation to separate out methanol and a crude product by boiling point differences among water, methanol, and the fatty acid methyl ester; introducing a gas phase product obtained by the crude product separation and evaporation system, i.e., methanol and water into a subsequent methanol recovery system, and introducing the crude product containing the fatty acid methyl ester and partially unreacted waste FOG into a product storage tank through a crude product conveying pump (P104A/B);
S4, introducing the aqueous phase product obtained by the oil-water separation in the chromatograph device (V102) into the catalyst recovery evaporation system, and conducting flash evaporation to separate out the ionic liquid, methanol, and water by boiling point differences among the ionic liquid, methanol, and water; introducing a gas phase product obtained by the catalyst recovery evaporation system, i.e., methanol and water into the subsequent methanol recovery system, returning most of the recovered ionic liquid catalyst to the catalyst preparation tank (V101), and introducing a deactivated ionic liquid into a waste catalyst recovery storage tank; and
S5, cooling the methanol and water from the crude product separation and evaporation system and the catalyst recovery evaporation system into a liquid through a methanol condenser (E105), and introducing the liquid into a methanol storage tank (V105); pressurizing the liquid by a methanol feed pump (P105A/B), and then introducing the liquid into the methanol recovery tower (T101) and conducting distillation separation to obtain high-purity gas phase methanol at a tower top and wastewater at a tower bottom; cooling the high-purity gas phase methanol by a tower top cooler (E107) to obtain a methanol product, refluxing a part of the methanol product and conveying back a part of the methanol product to the 1# reactor (R101) by a reflux pump (P107A/B); and conveying the wastewater obtained at the tower bottom to a waste liquid recovery storage tank through a waste liquid discharge pump (P106A/B).

11. The chemical pretreatment process for the waste FOG according to claim 10, wherein the crude product separation and evaporation system in step S3 comprises a 1# evaporator (E103) and a 1# gas-liquid separator (V103) disposed in series, and
the catalyst recovery evaporation system in steps S1 and S4 comprises a 2# evaporator (E104) and a 2# gas-liquid separator (V104) disposed in series.

12. The chemical pretreatment process for the waste FOG according to claim 10, wherein the ionic liquid catalyst in step S1 is a Bronsted acid protic ionic liquid prepared from a linear or heterocyclic tertiary amine compound and sulfuric acid, benzenesulfonic acid, or p-toluenesulfonic acid by one-step neutralization reaction.

13. The chemical pretreatment process for the waste FOG according to claim 10, wherein in step S1, a mass ratio of reaction raw materials to the catalyst is in a range of waste FOG:methanol:catalyst of 1:(0.4 to 1.6):(0.05 to 0.50), the 1# esterification reactor (R101) and the 2# esterification reactor (R102) have an operating temperature of 60° C. to 90° C., a reaction pressure of 0.1 MPa to 0.5 MPa, and a material residence time in both esterification reactors of 3 h to 5 h.

14. The chemical pretreatment process for the waste FOG according to claim 10, wherein the chromatograph device (V102) in step S2 has an operating temperature of 40° C. to 80° C., and an operating pressure of 0.1 MPa to 0.5 MPa.

15. The chemical pretreatment process for the waste FOG according to claim 10, wherein in step S3, the crude product separation and evaporation system has an operating temperature of 105° C. to 165° C., an operating pressure of 0.1 MPa to 0.5 Mpa; a low-pressure steam of a heating medium in the 1# evaporator (E103) has a temperature of 140° C. to 180° C., and a pressure of 0.3 MPa to 0.8 Mpa; and a heated steam condensate is supplied to a previous esterification reaction section for providing heat; and
in step S4, the catalyst recovery evaporation system has an operating temperature of 100° C. to 160° C., and an operating pressure of 0.1 MPa to 0.5 MPa; a low-pressure steam of a heating medium in the 2# evaporator (E104) has a temperature of 140° C. to 180° C., and a pressure of 0.3 MPa to 0.8 MPa; and a heated steam condensate is supplied to the previous esterification reaction section for providing heat.

16. The chemical pretreatment process for the waste FOG according to claim 10, wherein in step S5, the methanol recovery tower (T101) has an operating pressure of 0.1 MPa to 0.5 MPa, an operating temperature at the tower top of 40° C. to 80° C., an operating temperature at the tower bottom of 80° C. to 120° C., and an operating reflux ratio of 1.0 to 5.0; a low-pressure steam of a heating medium at the tower bottom has a temperature of 100° C. to 140° C., and a pressure of 0.1 MPa to 0.3 MPa; and a heated steam condensate is supplied to the previous esterification reaction section for providing heat.

17. The chemical pretreatment process for the waste FOG according to claim 10, wherein the both esterification reactors in step S1 are stirred tank reactors internally provided with an inner coil heater and an external circulation heat exchanger (E101/E102) for heating, and a heating medium is a steam condensate from a subsequent working section; when the reaction is out of control and overtemperature occurs, a recycled water is added to reduce a temperature of the reaction through the external circulation heat exchanger (E101/E102), and a reaction pressure is controlled by supplementing a low-pressure nitrogen.

18. The chemical pretreatment process for the waste FOG according to claim 10, wherein in order to prevent clogging from affecting normal operation, the filter connecting with the chromatograph device (V102) in step S2 is provided with two filter devices disposed in parallel, namely a first filter (F101A) and a second filter (F101B), one is put into normal use and the other is regularly back-flushed.
